(19) United States
(12) Patent Application Publication
(10) Pub. No.: US 2020/0068896 A1
(43) Pub. Date: Mar. 5, 2020

(54) CLEANING COMPOSITION INCLUDING BOTH A DISINFECTANT AND A LONG-LASTING ANTIMICROBIAL COMPONENT

(71) Applicant: Parasol Medical LLC, Buffalo Grove, IL (US)

(72) Inventor: Patrick E. Eddy, Allendale, MI (US)

(73) Assignee: Parasol Medical LLC, Buffalo Grove, IL (US)

(21) Appl. No.: 16/120,881

(22) Filed: Sep. 4, 2018

(51) Int. Cl. A01N 55/00; A01N 25/00

(52) U.S. Cl. CPC A01N 55/00; A01N 25/00

(57) ABSTRACT

A cleaning composition comprising: a disinfectant; and an antimicrobial component including a silane quaternary ammonium ion or salt thereof. The disinfectant can include ortho-phthalaldehyde, peracetic acid, glutaraldehyde, a phenol, sodium hypochlorite, hydrogen peroxide, among other disinfectants. Such other disinfectants include two or more of octyldecyldimethyl ammonium chloride, dioctyldimethyl ammonium chloride, didecyldimethyl ammonium chloride, and n-alkyl (C14 to C16) dimethylbenzyl ammonium chloride. The silane quaternary ammonium ion or salt thereof can be one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride. The silane quaternary ammonium ion or salt thereof can constitute 0.05% to 5% by weight of the cleaning composition. The phenol can constitute 0.10% to 2.0% by weight of the cleaning composition. The cleaning composition can further include a propellant, and the cleaning composition can be contained in an aerosol can.

### BACKGROUND OF THE INVENTION

Healthcare facilities are required to disinfect various surfaces to kill microorganisms present on those surfaces, in order to reduce the likelihood of transmission of the microorganisms to patients and other people. The transmission of the microorganisms to patients and other people could cause illness. Such microorganisms include Mycobacterium tuberculosis and other bacteria, fungi, and viruses. Various disinfectants are available in the marketplace for healthcare facilities to purchase. The disinfectant provides quick log reduction of the microorganisms on the surfaces to which the disinfectant is applied. Surfaces commonly cleaned with a disinfectant include critical and non-critical medical equipment and environmental surfaces (such as bedside tables, bedrails, and laboratory surfaces).

However, disinfecting is a continuous, laborious, and expensive effort for healthcare facilities.

### BRIEF SUMMARY OF THE INVENTION

The present disclosure solves that problem with a cleaning composition that includes both a disinfectant, which provides quick log reduction of microorganisms present on the surface to which the cleaning composition is applied, and an antimicrobial component that adheres and/or bonds to the surface to provide long-term ability to kill microorganisms that subsequently become present on the surface to which the cleaning composition is applied. The cleaning composition thus reduces the need for the healthcare facility to continuously disinfect the surfaces (the antimicrobial component preventing infection of the surfaces), saving labor and material costs, which can then be diverted to other areas of improving patient care.

The present disclosure further saves labor costs for healthcare facilities with an aerosol can that includes a propellant and an antimicrobial solution. The aerosol can can further include a disinfectant. Thus, the healthcare facility can apply the antimicrobial solution to less critical surfaces, where disinfecting is not required, more quickly than other application methods such as wipes. In addition, if the aerosol can further includes a disinfectant, the healthcare facility can most quickly apply the disinfectant and antimicrobial as above to more critical surfaces to kill microorganisms and further provide long term antimicrobial capability to the surfaces.

According to a first aspect of the present disclosure, a cleaning composition comprises: a disinfectant; and an antimicrobial component including a silane quaternary ammonium ion or salt thereof.

Embodiments of the first aspect of the invention can include any one or a combination of the following features:
the disinfectant includes ortho-phthalaldehyde;
the ortho-phthalaldehyde constitutes 0.275 percent to 0.65 percent by weight of the cleaning composition;
the disinfectant includes peracetic acid;
the peracetic acid constitutes 0.04 to 0.35 percent by weight of the cleaning composition;
the disinfectant includes glutaraldehyde;
the glutaraldehyde constitutes 1.2 to 3.5 percent by weight of the cleaning composition;
the disinfectant includes two or more of the following: octyldecyldimethyl ammonium chloride, dioctyldimethyl ammonium chloride, didecyldimethyl ammonium chloride, and n-alkyl (C14 to C16) dimethylbenzyl ammonium chloride;
octyldecyldimethyl ammonium chloride constitutes 0.0127% to 0.102% by weight of the cleaning composition, dioctyldimethyl ammonium chloride constitutes 0.00509% to 0.0407% by weight of the cleaning composition, didecyldimethyl ammonium chloride constitutes 0.00763% to 0.061% by weight of the cleaning composition, and n-alkyl (C14 to C16) dimethylbenzyl ammonium chloride constitutes 0.017% to 0.136% by weight of the cleaning composition;
octyldecyldimethyl ammonium chloride constitutes 0.0127% to 0.0254% by weight of the cleaning composition, dioctyldimethyl ammonium chloride constitutes 0.00636% to 0.0127% by weight of the cleaning composition, didecyldimethyl ammonium chloride constitutes 0.00636% to 0.0127% by weight of the cleaning composition, and n-alkyl (C14 to C16) dimethylbenzyl ammonium chloride constitutes 0.0170% to 0.0339% by weight of the cleaning composition;
didecyldimethyl ammonium chloride constitutes 0.0198% to 0.0396% by weight of the cleaning composition, and n-alkyl (C14 to C16) dimethylbenzyl ammonium chloride constitutes 0.0264% to 0.132% by weight of the cleaning composition
the disinfectant includes a phenol;
the phenol constituting 0.10% to 2.0% by weight of the cleaning composition;
the cleaning composition further includes a propellant, the phenol is ortho-phenylphenol, and the cleaning composition is contained in an aerosol can;
the disinfectant includes sodium hypochlorite;
the sodium hypochlorite constitutes 1.5% to 12.5% of the cleaning composition;
the disinfectant includes hydrogen peroxide;
the hydrogen peroxide constitutes 0.05% to 7.5% by weight of the cleaning composition;
the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride; and
the silane quaternary ammonium ion or salt thereof constitutes 0.05% to 5% by weight of the cleaning composition.

According to a second aspect of the present disclosure, contents of an aerosol can comprise: a propellant; and a solution comprising a silane quaternary ammonium ion or salt thereof; wherein, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride.

Embodiments of the second aspect of the invention can include any one or a combination of the following features:
the contents further comprise one or more disinfectants selected from the group consisting of: ortho-phthalaldehyde; peracetic acid; glutaraldehyde; a phenol; hydrogen peroxide; sodium hypochlorite; and (any two or more of the following: octyldecyldimethyl ammonium chloride, dioctyldimethyl ammonium chloride, didecyldimethyl ammonium chloride, and n-alkyl (C14 to C16) dimethylbenzyl ammonium chloride).

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a cut away view of an aerosol can, illustrating the contents of the aerosol can including a propellant and a solution, which includes a silane quaternary ammonium ion or salt thereof as an antimicrobial component and optionally one or more disinfectants.

### DETAILED DESCRIPTION

For purposes of description herein, it is to be understood that the specific devices and processes illustrated in the attached drawings, and described in the following specification are simply exemplary embodiments of the inventive concepts defined in the appended claims. Hence, physical characteristics relating to the embodiments disclosed herein are not to be considered as limiting, unless the claims expressly state otherwise.

In an embodiment, a cleaning composition of the present disclosure includes both a disinfectant and an antimicrobial component. A preferred antimicrobial component is a silane quaternary ammonium ion or salt thereof. Silane quaternary ammonium ions or salts thereof bond to the surface to which ions or salts thereof are applied, imparting long-lasting antimicrobial properties to the surface. In some embodiments, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride.

In an embodiment, the silane quaternary ammonium ion or salt thereof is part of a solution, before being mixed with the disinfectant (or a solution including the disinfectant). The solution, of which the silane quaternary ammonium ion or salt thereof is part, can thus further include a solvent. A preferred solvent is isopropyl alcohol. The silane quaternary ammonium ion or salt thereof can comprise between 0.1 percent and 10 percent by weight of the solution. More preferably, the silane quaternary ammonium ion or salt thereof can comprise between 0.75 percent and 5 percent by weight of the solution. Even more preferably, the silane quaternary ammonium ion or salt thereof can comprise between 1.9 percent and 2.1 percent by weight of the solution. As for the isopropyl alcohol, the isopropyl alcohol can comprise between 30 percent to 90 percent by weight of the solution. More preferably, the isopropyl alcohol can comprise between 55 percent and 65 percent by weight of the solution. An example preferable solution comprises (by weight) 60.0 percent isopropyl alcohol, 2.02 percent 3-(trimethoxysilyl)propyldimethyloctadecyl ammonium chloride, and 34.19 percent deionized water.

The disinfectant can be any disinfectant capable of quickly reducing the amount of microorganisms on the surface to which the disinfectant is applied. The disinfectant is typically available in the form of a solution that includes the disinfectant. In an embodiment, the cleaning composition is made by mixing (1) the solution that includes the disinfectant to impart the disinfectant to the cleaning composition with (2) a solution including the antimicrobial component to impart to the antimicrobial component to the cleaning composition, such as, for example, the solution including (by weight) 60.0 percent isopropyl alcohol, 2.02 percent 3-(trimethoxysilyl)propyldimethyloctadecyl ammonium chloride, and 34.19 percent deionized water. The solution including the antimicrobial component can be between 0.01 percent by weight and 50 percent by weight of the cleaning composition. The balance of the cleaning composition can include the solution that includes the disinfectant. In any event, the silane quaternary ammonium ion or salt thereof constitutes, in some embodiments, 0.05% to 10% by weight of the cleaning composition.

In an embodiment, the disinfectant is ortho-phthalaldehyde. Ortho-phthalaldehyde demonstrates microbiocidal, mycobactericidal, bactericidal, and sporicidal activity. Ortho-phthalaldehyde is used as a disinfectant and is commercially available in the form of a solution (Rapicide OPA-28CIDEX OPA, Minntech Corporation, Minnesota; Advanced Sterilization Products, CA; OPA 30, Ciden Technologies, LLC, Massachusetts; among others) that includes 0.55% to 0.60% by weight ortho-phthalaldehyde, depending upon the supplier. In an embodiment, the cleaning composition is made by mixing (1) 50% by weight to 99.9% by weight of the solution that includes 0.55% to 0.60% by weight ortho-phthalaldehyde with (2) 0.01% by weight to 50% by weight of the solution that includes the antimicrobial component. A resulting cleaning composition will thus include 0.275 percent by weight to 0.60 percent by weight ortho-phthalaldehyde. In another embodiment, the cleaning composition is made by dissolving ortho-phthalaldehyde and the silane quaternary ammonium ion or salt thereof in a solvent such that the cleaning composition comprises (by weight) 0.275 percent to 0.60 percent ortho-phthalaldehyde, and 0.05 percent and 10 percent silane quaternary ammonium ion or salt thereof.

In another embodiment, the disinfectant is peracetic acid. Peracetic acid demonstrates sporicidal, bactericidal, virucidal, and fungicidal activity. Peracetic acid is used as a disinfectant and is commercially available in solutions (Peract 20, Minntech Corporation, Minnesota; Acecide-C, Best Sanitizers, Inc., California; Steris S40 Sterilant Concentrate, Steris Corporation, Missouri; among others) that include, after any required dilution, between 0.08% weight percent and 0.35% by weight peracetic acid, depending on the supplier. In an embodiment, the cleaning composition is made by mixing (1) 50% by weight to 99.9% by weight of the solution, after any required dilution, that includes between 0.08% weight and 0.35% percent peracetic acid with (2) 0.01% by weight to 50% by weight of the solution that includes the antimicrobial component. A resulting cleaning composition will thus include 0.04 percent by weight to 0.35 percent by weight peracetic acid. In another embodiment, the cleaning composition is made by mixing peracetic acid and the silane quaternary ammonium ion or salt thereof dissolved in a solvent such that the cleaning composition comprises (by weight) 0.08 percent to 0.35 percent peracetic acid and 0.05 percent and 10 percent silane quaternary ammonium ion or salt thereof.

In another embodiment, the disinfectant is glutaraldehyde (including either an alkaline glutaraldehyde or an acid glutaraldehyde, or a combination of both). Glutaraldehyde demonstrates bactericidal, sporicidal, fungicidal and virucidal activity. Glutaraldehyde is used as a disinfectant and is commercially available in the form of a solution (Cidex Activated Dialdehyde Solution, Advanced Sterilization Products; Wavicide, Wave Energy Systems, New Jersey; Cidex Plus™ 28 Day Solution, Johnson & Johnson Medical Products; Sporicidin Sterilizing and Disinfecting Solution, Sporicidin International, South Carolina; Banicide Advanced, Pascal Company, Inc., Washington; among others) that include between 1.12% glutaraldehyde and 3.5% glutaraldehyde, depending on the supplier. In an embodiment, the cleaning composition is made by mixing (1) 50% by weight to 99.9% by weight of the solution that includes 1.12 to 3.5 weight percent glutaraldehyde with (2) 0.01% by weight to 50% by weight of the solution that includes the antimicrobial component. A resulting cleaning composition will thus include 0.56 percent by weight 1.75 percent by weight glutaraldehyde. In another embodiment, the cleaning composition is made by dissolving glutaraldehyde and the silane quaternary ammonium ion or salt thereof in a solvent such that the cleaning composition comprises (by weight) 1.12 percent to 3.5 percent glutaraldehyde and 0.05 percent and 10 percent silane quaternary ammonium ion or salt thereof.

In another embodiment, the disinfectant is hydrogen peroxide. Hydrogen peroxide demonstrates bactericidal, virucidal, sporicidal, and fungicidal activity. Hydrogen peroxide is used as a disinfectant and is commercially available in the form of a solution (Peract 20, Minntech Corporation, Minnesota; Resert XL HLD, Steris Corporation, Ohio; Sporox, Reckitt & Colman Inc., United Kingdom; among others) that includes between 1.0% and 7.5% hydrogen peroxide. In an embodiment, the cleaning composition is made by mixing (1) 50% by weight to 99.9% by weight of the solution that includes 1.0 to 7.5 weight percent hydrogen peroxide with (2) 0.01% by weight to 50% by weight of the solution that includes the antimicrobial component. A resulting cleaning composition will thus include 0.05 percent by weight 7.5 percent by weight hydrogen peroxide. In another embodiment, the cleaning composition is made by mixing hydrogen peroxide and a solution containing the silane quaternary ammonium ion or salt thereof such that the cleaning composition comprises (by weight) 1.0 percent to 7.5 percent hydrogen peroxide and 0.05 percent and 10 percent silane quaternary ammonium ion or salt thereof.

In another embodiment, the disinfectant is a chlorine releasing agent (such as a hypochlorite like sodium hypochlorite). Chlorine releasing agents demonstrate antimicrobial, sporicidal, and virucidal activity. Chlorine releasing agents are used as a disinfectant and are commercially available in the form of a solution (Clorox Bleach Germicidal Cleaner, The Clorox Company, California; among others) that includes 0.65% sodium hypochlorite. In an embodiment, the cleaning composition is made by mixing (1) 50% by weight to 99.9% by weight of the solution that includes 0.65 weight percent sodium hypochlorite with (2) 0.01% by weight to 50% by weight of the solution that includes the antimicrobial component. A resulting cleaning composition will thus include 0.325 percent by weight to 0.65 percent by weight sodium hypochlorite. In another embodiment, the cleaning composition is made by mixing sodium hypochlorite and a solution containing the silane quaternary ammonium ion or salt thereof such that the cleaning composition comprises (by weight) 0.325 percent to 12.5 percent sodium hypochlorite and 0.05 percent and 10 percent silane quaternary ammonium ion or salt thereof.

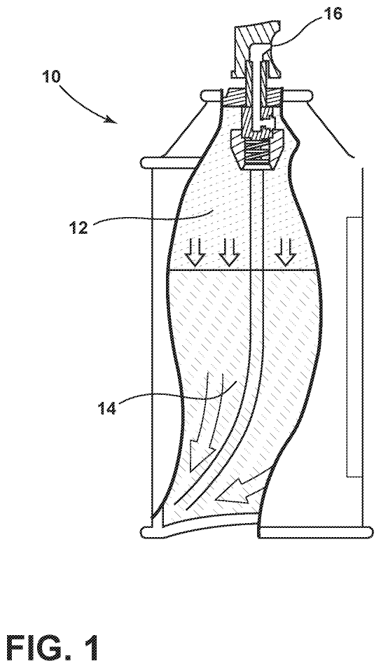

In another embodiment, the disinfectant is a phenol (including phenol derivatives such as ortho-phenylphenol and ortho-benzyl-para-chlorophenol). Phenols demonstrate tuberculocidal, fungicidal, virucidal, and bactericidal activity. Phenols are used as a disinfectant and are commercially available in the form of solutions (Activated Sporicidin Sterilizing and Disinfecting Solution, American Air & Water, Inc., South Carolina; Professional Amphyl Disinfectant Cleaner, Reckitt Benckiser, New Jersey; among others) that include 1.92% by weight phenol, for the former, and 0.105% ortho-phenylphenol and 0.05% ortho-benzyl-para-chlorophenol after dilution, for the latter. Another phenol derivative disinfectant is commercially available in the form of contents of an aerosol can (Precise Hospital Foam Cleaner, Caltech Industries, Michigan) that include 0.37% ortho-phenylphenol. In an embodiment, the cleaning composition is made by mixing a phenol and a solution containing the silane quaternary ammonium ion or salt thereof such that the cleaning composition comprises (by weight) 0.10 percent to 2.0 percent phenol and 0.05 percent and 10 percent silane quaternary ammonium ion or salt thereof. In another embodiment, the cleaning composition is contained in an aerosol can 10 (see FIG. 1), the phenol is ortho-phenylphenol (preferably 0.37% by weight), and the aerosol can further includes a propellant 12.

In another embodiment, the disinfectant is a quaternary ammonium compound. Quaternary ammonium compounds demonstrate mycobacteriostatic and sporostatic activity. Example quaternary ammonium compounds include octyldecyldimethyl ammonium chloride, dioctyldimethyl ammonium chloride, didecyldimethyl ammonium chloride, and n-alkyl (C14 to C16) dimethylbenzyl ammonium chloride. In some embodiments, the disinfectant component of the cleaning composition can include two or more of the preceding quaternary ammonium chlorides. Quaternary ammonium compounds are used as disinfectants and are commercially available in the form of a solution. An example is A-45611 (Ecolab, Inc., Minnesota), which, after dilution, includes 0.0254% to 0.102% by weight octyldecyldimethyl ammonium chloride, 0.0102% to 0.0407% by weight dioctyldimethyl ammonium chloride; 0.0153% to 0.0610% by weight didecyldimethyl Ammonium Chloride, and 0.0339% to 0.136% by weight n-alkyl (C14 50%; C12 40%; C16 10%) dimethylbenzyl ammonium chloride. In an embodiment, the cleaning composition is made by mixing (1) 50% by weight to 99.9% by weight of the solution that includes 0.0254% to 0.102% by weight octyldecyldimethyl ammonium chloride, 0.0102% to 0.0407% by weight dioctyldimethyl ammonium chloride; 0.0153% to 0.0610% by weight didecyldimethyl Ammonium Chloride, and 0.0339% to 0.136% by weight n-alkyl (C14 50%; C12 40%; C16 10%) dimethylbenzyl ammonium chloride with (2) 0.01% by weight to 50% by weight of the solution that includes the antimicrobial component. A resulting cleaning composition will thus include 0.0127% to 0.102% by weight octyldecyldimethyl ammonium chloride, 0.00509% to 0.0407% by weight dioctyldimethyl ammonium chloride, 0.00763% to 0.061% by weight didecyldimethyl ammonium chloride, and 0.017% to 0.136% by weight-alkyl (C14 to C16) dimethylbenzyl ammonium chloride. In another embodiment, the cleaning composition is made by mixing octyldecyldimethyl ammonium chloride, dioctyldimethyl ammonium chloride, didecyldimethyl ammonium chloride, and n-alkyl (C14 50%; C12 40%; C16 10%) dimethylbenzyl ammonium chloride and a solution containing the silane quaternary ammonium ion or salt thereof such that the cleaning composition comprises 0.0254% to 0.102% by weight octyldecyldimethyl ammonium chloride, 0.0102% to 0.0407% by weight dioctyldimethyl ammonium chloride, 0.0153% to 0.0610% by weight didecyldimethyl Ammonium Chloride, 0.0339% to 0.136% by weight n-alkyl (C14 50%; C12 40%; C16 10%) dimethylbenzyl ammonium chloride, and 0.05 percent and 10 percent silane quaternary ammonium ion or salt thereof.

Another example is Re-Juv-Nal (Hillyard, Missouri), which, after dilution, includes 0.0254% by weight octyldecyldimethyl ammonium chloride, 0.0127% by weight dioctyldimethyl ammonium chloride, 0.0127% by weight didecyldimethyl ammonium chloride, and 0.0339% by weight n-alkyl (50% C14, 40% C12, 10% C16) dimethylbenzyl ammonium chloride. In an embodiment, the cleaning composition is made by mixing (1) 50% by weight to 99.9% by weight of the solution that includes 0.0254% by weight octyldecyldimethyl ammonium chloride, 0.0127% by weight dioctyldimethyl ammonium chloride, 0.0127% by weight didecyldimethyl ammonium chloride, and 0.0339% by weight n-alkyl (50% C14, 40% C12, 10% C16) dimethylbenzyl ammonium chloride with (2) 0.01% by weight to 50% by weight of the solution that includes the antimicrobial component. A resulting cleaning composition will thus include 0.0127% to 0.0254% by weight octyldecyldimethyl ammonium chloride, 0.00636% to 0.0127% by weight dioctyldimethyl ammonium chloride, 0.00636% to 0.0127% by weight didecyldimethyl ammonium chloride, and 0.170% to 0.0339% by weight n-alkyl (50% C14, 40% C12, 10% C16) dimethylbenzyl ammonium chloride. In another embodiment, the cleaning composition is made by mixing octyldecyldimethyl ammonium chloride, dioctyldimethyl ammonium chloride, didecyldimethyl ammonium chloride, and n-alkyl (50% C14, 40% C12, 10% C16) dimethylbenzyl ammonium chloride, and a solution containing the silane quaternary ammonium ion or salt thereof such that the cleaning composition comprises 0.01% to 0.05% by weight octyldecyldimethyl ammonium chloride, 0.005% to 0.05% by weight dioctyldimethyl ammonium chloride, 0.005% to 0.05% by weight didecyldimethyl ammonium chloride, and 0.01% to 0.05% by weight n-alkyl (50% C14, 40% C12, 10% C16) dimethylbenzyl ammonium chloride, and 0.05 percent and 10 percent silane quaternary ammonium ion or salt thereof.

Another example is Super HDQ Neutral (Spartan Chemical Company, Inc., Ohio), which, after dilution, includes 0.0396% by weight didecyldimethyl ammonium chloride and 0.0264% by weight n-alkyl (50% C14, 40% C12, 10% C16) dimethylbenzyl ammonium chloride. In an embodiment, the cleaning composition is made by mixing (1) 50% by weight to 99.9% by weight of the solution that includes 0.0396% by weight didecyldimethyl ammonium chloride and 0.0264% by weight n-alkyl (50% C14, 40% C12, 10% C16) dimethylbenzyl ammonium chloride with (2) 0.01% by weight to 50% by weight of the solution that includes the antimicrobial component. A resulting cleaning composition will thus include 0.0198% to 0.0396% by weight didecyldimethyl ammonium chloride, and 0.132% to 0.0264% by weight n-alkyl (50% C14, 40% C12, 10% C16) dimethylbenzyl ammonium chloride. In another embodiment, the cleaning composition is made by mixing didecyldimethyl ammonium chloride and n-alkyl (50% C14, 40% C12, 10% C16) dimethylbenzyl ammonium chloride, and a solution containing the silane quaternary ammonium ion or salt thereof such that the cleaning composition comprises 0.01% to 0.05% by weight didecyldimethyl ammonium chloride, 0.01% to 0.05% by weight n-alkyl (50% C14, 40% C12, 10% C16) dimethylbenzyl ammonium chloride, and 0.05 percent and 10 percent silane quaternary ammonium ion or salt thereof.

Referring now to FIG. 1, the contents of an aerosol can 10 include a propellant 12 and a solution 14 that includes a silane quaternary ammonium ion or salt thereof. As described above, the silane quaternary ammonium ion or salt thereof is preferably one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride. In an embodiment, the solution 14 further includes one or more disinfectants. The one or more disinfectants can include any of the following: ortho-phthalaldehyde; peracetic acid; glutaraldehyde; a phenol (including ortho-phenylphenol); sodium hypochlorite; hydrogen peroxide; and any two or more of the following: octyldecyldimethyl ammonium chloride, dioctyldimethyl ammonium chloride, didecyldimethyl ammonium chloride, and n-alkyl (C14 to C16) dimethylbenzyl ammonium chloride. The silane quaternary ammonium ion or salt thereof can be 0.05% to 10% by weight of the solution. The one or more disinfectants can be 0.01% to 5% by weight of the solution. As known in the aerosol can 10 field, the propellant 12 mixes with the solution 14 and creates a mist of propellant 12 and solution 14 upon release from a nozzle 16. The solution 14 containing the silane quaternary ammonium ion or salt thereof and, optionally, the one or more disinfectants, can thus be sprayed onto a surface by a user to provide long-lasting antimicrobial properties and, optionally, quickly disinfect the surface.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A cleaning composition comprising:
a disinfectant; and
an antimicrobial component including a silane quaternary ammonium ion or salt thereof.

2. The cleaning composition of claim 1, the disinfectant including ortho-phthalaldehyde.

3. The cleaning composition of claim 2, the ortho-phthalaldehyde constituting 0.275 percent to 0.65 percent by weight of the cleaning composition.

4. The cleaning composition of claim 1, the disinfectant including peracetic acid.

5. The cleaning composition of claim 4, the peracetic acid constituting 0.04 to 0.35 percent by weight of the cleaning composition.

6. The cleaning composition of claim 1, the disinfectant including glutaraldehyde.

7. The cleaning composition of claim 6, the glutaraldehyde constituting 1.2 to 3.5 percent by weight of the cleaning composition.

8. The cleaning composition of claim 1, the disinfectant including two or more of the following: octyldecyldimethyl ammonium chloride, dioctyldimethyl ammonium chloride, didecyldimethyl ammonium chloride, and n-alkyl (C14 to C16) dimethylbenzyl ammonium chloride.

9. The cleaning composition of claim 8, octyldecyldimethyl ammonium chloride constituting 0.0127% to 0.102% by weight of the cleaning composition, dioctyldimethyl ammonium chloride constituting 0.00509% to 0.0407% by weight of the cleaning composition, didecyldimethyl ammonium chloride constituting 0.00763% to 0.061% by weight of the cleaning composition, and n-alkyl (C14 to C16) dimethylbenzyl ammonium chloride constituting 0.017% to 0.136% by weight of the cleaning composition.

10. The cleaning composition of claim 8, octyldecyldimethyl ammonium chloride constituting 0.0127% to 0.0254% by weight of the cleaning composition, dioctyldimethyl ammonium chloride constituting 0.00636% to 0.0127% by weight of the cleaning composition, didecyldimethyl ammonium chloride constituting 0.00636% to 0.0127% by weight of the cleaning composition, and n-alkyl (C14 to C16) dimethylbenzyl ammonium chloride constituting 0.0170% to 0.0339% by weight of the cleaning composition.

11. The composition of claim 8, didecyldimethyl ammonium chloride constituting 0.0198% to 0.0396% by weight of the cleaning composition, and n-alkyl (C14 to C16) dimethylbenzyl ammonium chloride constituting 0.0264% to 0.132% by weight of the cleaning composition.

12. The cleaning composition of claim 1, the disinfectant including a phenol.

13. The cleaning composition of claim 12, the phenol constituting 0.10% to 2.0% by weight of the cleaning composition.

14. The cleaning composition of claim 13 further comprising a propellant, the phenol is ortho-phenylphenol, and the cleaning composition is contained in an aerosol can.

15. The cleaning composition of claim 1, the disinfectant including sodium hypochlorite.

16. The cleaning composition of claim 15, the sodium hypochlorite constituting 1.5% to 12.5% by weight of the cleaning composition.

17. The cleaning composition of claim 1, the disinfectant including hydrogen peroxide.

18. The cleaning composition of claim 17, the hydrogen peroxide constituting 0.05% to 7.5% by weight of the cleaning composition.

19. The cleaning composition of claim 1, wherein the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride.

20. The cleaning composition of claim 19, wherein the silane quaternary ammonium ion or salt thereof constitutes 0.05% to 5% by weight of the cleaning composition.

21. Contents of an aerosol can comprising:
a propellant; and
a solution comprising a silane quaternary ammonium ion or salt thereof;
wherein, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride.

22. The contents of claim 21 further comprising one or more disinfectants selected from the group consisting of:
ortho-phthalaldehyde;
peracetic acid;
glutaraldehyde;
a phenol;
hydrogen peroxide;
sodium hypochlorite; and
any two or more of the following: octyldecyldimethyl ammonium chloride, dioctyldimethyl ammonium chloride, didecyldimethyl ammonium chloride, and n-alkyl (C14 to C16) dimethylbenzyl ammonium chloride.
